(19) United States
(12) Patent Application Publication
(10) Pub. No.: US 2025/0122823 A1
(43) Pub. Date: Apr. 17, 2025

(54) THERMAL MANAGEMENT SYSTEM

(71) Applicant: TOYOTA JIDOSHA KABUSHIKI KAISHA, Toyota-shi (JP)

(72) Inventor: Issei SEKI, Toyokawa-shi (JP)

(73) Assignee: TOYOTA JIDOSHA KABUSHIKI KAISHA, Toyota-shi (JP)

(21) Appl. No.: 18/827,955

(22) Filed: Sep. 9, 2024

(30) Foreign Application Priority Data
Oct. 17, 2023 (JP) 2023-178763

(51) Int. Cl. F01P 7/16; F01P 7/14; F02M 21/02

(52) U.S. Cl. CPC F01P 7/16; F02M 21/0206; F02M 21/0287; F01P 2007/146

(57) ABSTRACT

A thermal management system is employed in a vehicle including a fuel supply system configured to supply hydrogen gas as fuel to an engine. The fuel supply system includes a tank configured to store the hydrogen gas, a fuel injection valve configured to inject the hydrogen gas, and a regulator configured to control a pressure of the hydrogen gas supplied from the tank to the fuel injection valve. The thermal management system includes a heat exchanger configured to exchange heat between coolant for the engine and the tank and a tank temperature control passage configured to cause the coolant that has flowed from the engine to return to the engine through the heat exchanger. The thermal management system includes an electromagnetic valve and processing circuitry. The processing circuitry is configured to adjust the amount of coolant flowing through the tank temperature control passage by controlling the electromagnetic valve.

### CROSS-REFERENCE TO RELATED APPLICATIONS

The present application claims priority to Japanese Patent Application No. 2023-178763, filed on Oct. 17, 2023, the disclosure of which is incorporated herein by reference in its entirety.

### BACKGROUND

### 1. Field

This disclosure relates to a thermal management system.

### 2. Description of Related Art

Japanese Laid-Open Patent Publication No. 2020-145117 discloses a thermal management system. In vehicles using hydrogen gas as fuel, the temperature in the tank increases when the hydrogen gas is filled into the tank. The thermal management system warms the fuel cell by exchanging heat between the heated tank and coolant for the fuel cell.

In vehicles that obtain power by burning hydrogen gas in the engine, the hydrogen gas stored in the tank is delivered to the fuel injection valve through a hydrogen gas pipe. The hydrogen gas pipe includes a regulator. The pressure of the hydrogen gas supplied to the fuel injection valve is adjusted by the regulator to a constant pressure. The hydrogen gas with the adjusted pressure is injected from the fuel injection valve.

The pressure of the hydrogen gas in the tank is decreased as the amount of hydrogen gas injected from the fuel injection valve increases. As the pressure of the hydrogen gas in the tank decreases, its temperature decreases. When the temperature of the hydrogen gas decreases, its volume decreases even if the pressure remains constant. In other words, when the temperature of the hydrogen gas decreases, its density increases. Thus, when the temperature of the hydrogen gas decreases, the amount of hydrogen supplied to the combustion chamber increases even if the hydrogen gas is regulated to a constant pressure by the regulator. Since the density of hydrogen gas changes with its temperature, changes in the temperature of the hydrogen gas in the tank reduce the accuracy of the fuel injection control.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An aspect of the present disclosure provides a thermal management system employed in a vehicle including a fuel supply system configured to supply hydrogen gas as fuel to an engine. The fuel supply system includes a tank configured to store the hydrogen gas, a fuel injection valve configured to inject the hydrogen gas, and a regulator configured to control a pressure of the hydrogen gas supplied from the tank to the fuel injection valve. The thermal management system includes a heat exchanger configured to exchange heat between coolant for the engine and the tank, a tank temperature control passage configured to cause the coolant that has flowed from the engine to return to the engine through the heat exchanger, an electromagnetic valve configured to regulate an amount of the coolant flowing through the tank temperature control passage, and processing circuitry configured to control the electromagnetic valve. The processing circuitry is configured to adjust the amount of coolant flowing through the tank temperature control passage by controlling the electromagnetic valve.

Other features and aspects will be apparent from the following detailed description, the drawings, and the claims.

### BRIEF DESCRIPTION OF THE DRAWINGS

FIG. 1 is a schematic diagram illustrating the configuration of a thermal management system according to an embodiment.

FIG. 2 is a flowchart illustrating a procedure for processes executed by the controller for the thermal management system shown in FIG. 1.

FIG. 3 is a graph illustrating the relationship between the amount of hydrogen gas injected by the fuel injection valve and the open degree of the electromagnetic valve determined by the controller in a vehicle incorporating the thermal management system shown in FIG. 1.

FIG. 4 is a graph illustrating the relationship between the amount of hydrogen gas injected by the fuel injection valve and the open degree of the electromagnetic valve determined by the controller in a vehicle incorporating the thermal management system according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

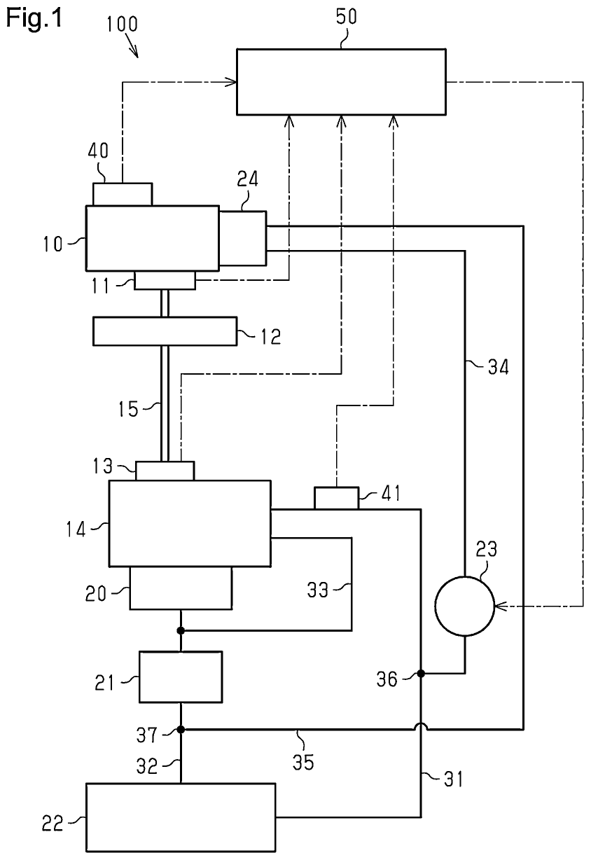

A thermal management system 100 according to an embodiment will now be described with reference to FIGS. 1 to 3. The thermal management system 100 is employed in hydrogen vehicles that use hydrogen gas as fuel.

### Configuration of Fuel Supply System

As shown in FIG. 1, the vehicle in which the thermal management system 100 is employed includes a tank 10 and a regulator 12 as part of the fuel supply system for an engine 14.

The tank 10 stores hydrogen gas supplied from outside the vehicle. The tank 10 is connected to the engine 14 by a hydrogen gas pipe 15. The hydrogen gas in the tank 10 is supplied to the engine 14 through the hydrogen gas pipe 15.

A shut-off valve 11 is installed at a connection portion between the tank 10 and the hydrogen gas pipe 15. The shut-off valve 11 selectively opens and closes depending on the state of the condition of the engine 14. When the engine 14 is running, the shut-off valve 11 is open. In this state, the hydrogen gas in the tank 10 is supplied to the engine 14 through the hydrogen gas pipe 15. When the engine 14 is running, the shut-off valve 11 is closed. In this state, the hydrogen gas in the tank 10 is not supplied to the engine 14 through the hydrogen gas pipe 15. Thus, the shut-off valve 11 controls whether hydrogen gas is supplied to the engine 14 based on the state of the engine 14.

The regulator 12 is located in the hydrogen gas pipe 15. The regulator 12 reduces the pressure of the hydrogen gas inside the hydrogen gas pipe 15. As a result, the hydrogen gas within the hydrogen gas pipeline 15 is controlled to a pressure suitable for being supplied as fuel to the engine 14.

Hydrogen gas having the pressure adjusted by the regulator 12 is injected into the engine 14 by the fuel injection valve 13. The fuel injection valve 13 injects hydrogen gas into the engine 14 based on information such as the accelerator operation amount in the vehicle, vehicle speed, intake air amount, and fuel pressure within the hydrogen gas pipe 15. The amount of hydrogen gas injected is controlled by regulating the period during which the fuel injection valve 13 is open. The longer the opening period of the fuel injection valve 13, the more the pressure of the hydrogen gas in the tank 10 decreases.

In this manner, the fuel system for the vehicle supplies hydrogen gas from the tank 10 to the engine 14.

### Configuration of Radiator Passage

The vehicle in which the thermal management system 100 is employed includes a radiator passage. Coolant flows through the radiator passage to cool the engine 14. As shown in FIG. 1, the radiator passage includes a first coolant pipe 31 and a second coolant pipe 32. The radiator passage further includes a water pump 20, a thermostat valve 21, and a radiator 22.

The engine 14 includes a water jacket. Coolant flows through the water jacket of the engine 14. The coolant flowing through the water jacket cools the engine 14 by exchanging heat with the engine 14.

The first coolant pipe 31 connects the engine 14 to the radiator 22. The coolant that has flowed from the engine 14 flows through the first coolant pipe 31 to the radiator 22.

The radiator 22 cools the coolant that has flowed from the first coolant pipe 31. Specifically, the radiator 22 cools the coolant that has been heated through heat exchange with the engine 14. The coolant that has been cooled by the radiator 22 flows into the second coolant pipe 32.

The second coolant pipe 32 connects the radiator 22 to the water pump 20. The coolant that has flowed through the radiator 22 reaches the water pump 20 through the second coolant pipe 32.

The water pump 20 circulates coolant within a coolant pipe by utilizing the rotation of the engine 14. The water pump 20 is connected to the water jacket of the engine 14. The water pump 20 circulates the coolant through the radiator passage in a direction that allows the coolant from the radiator 22 to flow into the engine 14.

The thermostat valve 21 is located in the second coolant pipe 32. The thermostat valve 21 opens and closes to regulate the flow of coolant in the radiator passage. The thermostat valve 21 opens and closes in response to the temperature of the coolant flowing through the second coolant pipe 32.

If the engine 14 has not completed warm-up, the temperature of the coolant in the radiator passage is relatively low. The thermostat valve 21 closes when the temperature of the coolant in the radiator passage is less than or equal to a specified value, thereby closing the second coolant pipe 32. In other words, the thermostat valve 21 ensures that, when the temperature of the coolant is less than or equal to the specified value, the coolant cooled by the radiator 22 does not reach the engine 14. The specified value has been determined in advance.

If the engine 14 has completed warm-up, the temperature of the coolant in the radiator passage is relatively high. The thermostat valve 21 opens when the temperature of the coolant in the radiator passage exceeds the specified value, thereby opening the second coolant pipe 32. In other words, the thermostat valve 21 ensures that, when the temperature of the coolant is greater than the specified value, the coolant cooled by the radiator 22 reaches the engine 14. This allows the thermostat valve 21 to regulate the flow of coolant in the radiator passage based on whether the engine 14 is in the process of warming up.

The third coolant pipe 33 connects the engine 14 to a portion of the second coolant pipe 32 located between the thermostat valve 21 and the water pump 20. When the thermostat valve 21 closes the second coolant pipe 32, the coolant flows through the third coolant pipe 33.

When the thermostat valve 21 is open, coolant flows from the engine 14 through the first coolant pipe 31 into the radiator 22. Then, the coolant flows through the second coolant pipe 32 and the thermostat valve 21 into the water pump 20, and returns to the engine 14. In this manner, the radiator passage cools the engine 14 using coolant.

When the thermostat valve 21 is closed, coolant flows from the engine 14 through the third coolant pipe 33 and the second coolant pipe 32 into the water pump 20, and returns to the engine 14. Thus, the radiator passage is configured so as not to interfere with the warm-up of the engine 14.

### Configuration of the Thermal Management System 100

The thermal management system 100 includes a tank temperature control passage. The tank temperature control passage allows coolant, which is used to heat the tank 10, to flow. As shown in FIG. 1, the tank temperature control passage includes a fourth coolant pipe 34 and a fifth coolant pipe 35. The tank temperature control passage also includes an electromagnetic valve 23 and a heat exchanger 24.

The tank temperature control passage is connected to the radiator passage. Some of the coolant flowing through the radiator passage enters the tank temperature control passage. The tank temperature control passage is connected to the radiator passage at a first connection point 36 and a second connection point 37.

The first connection point 36 is located at a portion of the radiator passage through which the coolant that has flowed from the engine 14 and has not yet reached the radiator 22. In other words, the first connection point 36 is located in the first coolant pipe 31.

The second connection point 37 is located at a portion of the radiator passage through which the coolant that has flowed through the radiator 22 and has not yet reached the thermostat valve 21 flows. In other words, the second connection point 37 is located at a portion between the second coolant pipe 32 between the radiator 22 and the thermostat valve 21.

The fourth coolant pipe 34 connects the first connection point 36 to the heat exchanger 24. Some of the coolant flowing through the first coolant pipe 31 enters the fourth coolant pipe 34 at the first connection point 36 to the heat exchanger 24.

The heat exchanger 24 allows heat exchange between the coolant and the tank 10. The heat exchanger 24 is installed around the tank 10. The heat exchanger 24 may be a coolant pipe arranged around the tank 10.

As previously mentioned, the hydrogen gas in the tank 10 has a lowered temperature due to the pressure reduction. As the temperature of the hydrogen gas decreases, the temperature in the tank 10 decreases. The temperature of the coolant flowing through the heat exchanger 24 rises as it exchanges heat with the engine 14. This allows the heat exchanger 24 to heat the tank 10 by enabling heat exchange between the coolant and the tank 10. The heat exchanger 24 can limit variations in the temperature of the hydrogen gas by heating the tank 10.

The electromagnetic valve 23 is installed in the fourth coolant pipe 34. The amount of coolant flowing through the tank temperature control passage is adjusted according to the open degree of the electromagnetic valve 23. When the open degree of the electromagnetic valve 23 is 0%, the tank temperature control passage is closed. In this state, coolant stops flowing from the engine 14 into the tank temperature control passage.

The fifth coolant pipe 35 connects the heat exchanger 24 to the second connection point 37. The coolant that has flowed through the heat exchanger 24 reaches the second connection point 37 through the fifth coolant pipe 35. Thus, the coolant that has flowed into the tank temperature control passage from the first connection point 36 merges with the coolant flowing through the radiator passage at the second connection point 37.

Thus, some of the coolant flowing from the engine 14 through the first coolant pipe 31 is diverted into the fourth coolant pipe 34 at the first connection point 36, and then enters the heat exchanger 24 through the electromagnetic valve 23. The coolant further flows through the fifth coolant pipe 35 and enters the second coolant pipe 32 at the second connection point 37. The coolant then flows through the thermostat valve 21 and the water pump 20 before returning to the engine 14.

As previously mentioned, the second connection point 37 is located between the radiator 22 and the thermostat valve 21. If the warm-up of the engine 14 is not completed, the thermostat valve 21 closes a portion of the radiator passage on the downstream side of the second connection point 37.

The temperature of the coolant flowing through the tank temperature control passage decreases by exchanging heat with the tank 10. The thermostat valve 21 prevents the engine 14, which is undergoing warm-up, from being cooled by the coolant flowing through the heat exchanger 24.

When warm-up of the engine 14 is completed, the thermostat valve 21 opens the portion of the radiator passage on the downstream side of the second connection point 37. In this state, as previously mentioned, the coolant that has flowed from the engine 14 flows through the first coolant pipe 31 into the radiator 22. Then, it returns to the engine 14 through the second coolant pipe 32.

When warm-up of the engine 14 is completed, the temperature of the coolant is increased due to heat exchange with the engine 14. Thus, in a state in which the thermostat valve 21 opens the portion of the radiator passage on the downstream side of the second connection point 37 and the electromagnetic valve 23 is open, the heated coolant flows through the tank temperature control passage. Thus, the thermostat valve 21 adjusts the flow not only in the radiator passage but also in the tank temperature control passage according to the temperature of the coolant. In this manner, the thermal management system 100 heats the tank 10 by utilizing the coolant after the warm-up is completed.

As shown in FIG. 1, the thermal management system 100 includes a controller 50 corresponding to processing circuitry. The controller 50 is an ECU provided in the vehicle. The controller 50 includes a storage device that stores programs and a processing device that executes the programs stored in the storage device. The controller 50 is communicatively connected to the shut-off valve 11, the fuel injection valve 13, the electromagnetic valve 23, the tank temperature sensor 40, and the coolant temperature sensor 41.

The shut-off valve 11 sends information related to its open or closed state to the controller 50. The fuel injection valve 13 sends information related to the amount of hydrogen gas injected into the controller 50.

The tank temperature sensor 40 is installed in the tank 10. The tank temperature sensor 40 acquires the temperature in the tank 10. The tank temperature sensor 40 sends the obtained temperature information of the tank 10 to the controller 50.

The coolant temperature sensor 41 is installed, for example, in a section of the first coolant pipe 31 between the engine 14 and the first connection point 36. The coolant temperature sensor 41 measures the temperature of the coolant flowing through the coolant pipe. The coolant temperature sensor 41 sends the acquired coolant temperature information to the controller 50. This allows the controller 50 to obtain the temperature of the coolant that has flowed from the engine 14 and has not yet reached the heat exchanger 24.

In this manner, the controller 50 obtains information from the shut-off valve 11, the fuel injection valve 13, the tank temperature sensor 40, and the coolant temperature sensor 41. Then, the controller 50 controls the electromagnetic valve 23 based on the acquired information.

### Processes Executed by Controller 50

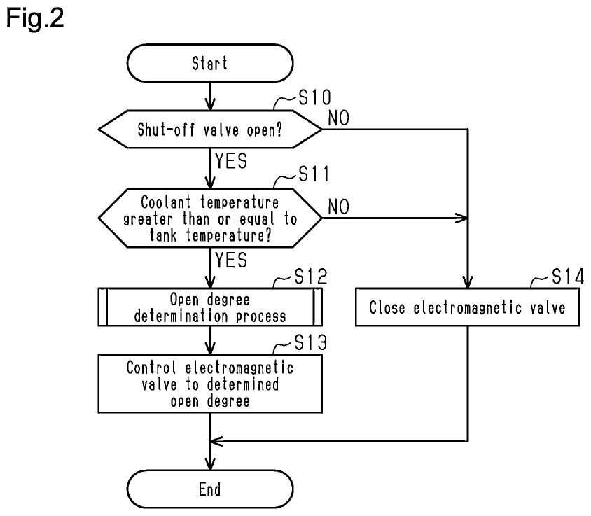

FIG. 2 illustrates a series of processes executed by the controller 50. The controller 50 executes this series of processes when it obtains information on the open or closed state from the shut-off valve 11.

In the process of step S10, the controller 50 determines whether the shut-off valve 11 is open based on the information related to the open-closed state from the shut-off valve 11. When the controller 50 determines that the shut-off valve 11 is open (step S10: YES), the process proceeds to step S11.

In the process of step S11, the controller 50 determines whether the temperature of the coolant is greater than or equal to the temperature in the tank 10. The temperature of the coolant, which is compared with the temperature in the tank 10, is the temperature of the coolant that has flowed from the engine 14 and has not yet reached the heat exchanger 24. The controller 50 compares the temperature of the coolant with the temperature in the tank 10 based on information obtained from the tank temperature sensor 40 and the coolant temperature sensor 41. When the controller 50 determines that the temperature of the coolant is greater than or equal to the temperature in the tank 10 (step S11: YES), the process proceeds to step S12.

In the process of step S12, the controller 50 performs an open degree determination process. The open degree determination process refers to a process that determines the open degree of the electromagnetic valve 23 based on the information regarding the amount of hydrogen gas injected by the fuel injection valve 13.

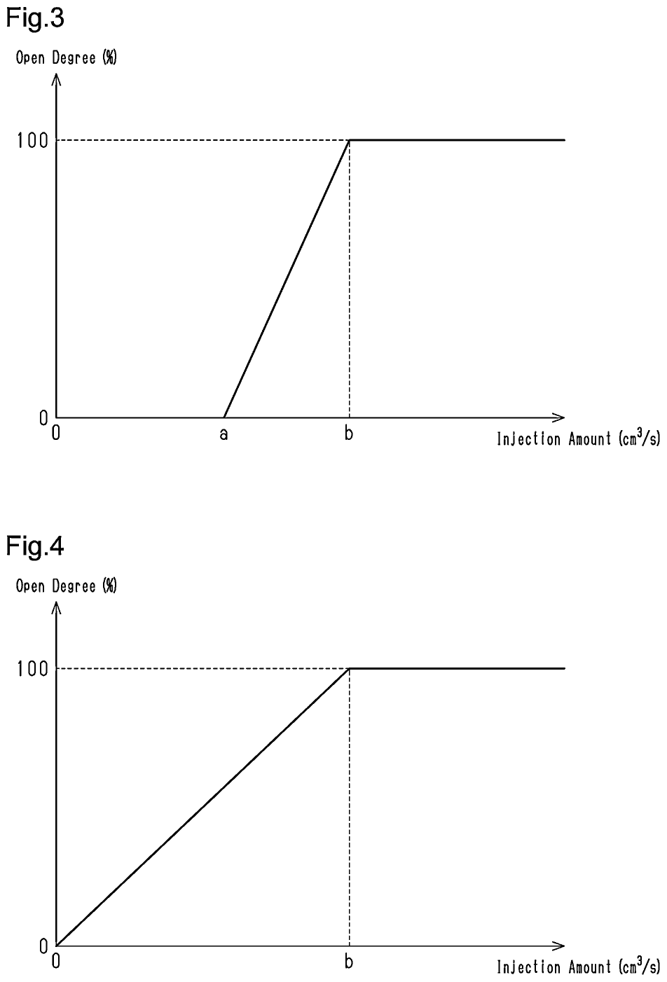

FIG. 3 is a graph illustrating the relationship between the amount of hydrogen gas injected by the fuel injection valve 13 and the open degree of the electromagnetic valve 23 determined by the controller 50 in the open degree determination process.

When the amount of hydrogen gas injected by the fuel injection valve 13 is relatively small, the decrease in the temperature of the hydrogen gas in the tank 10 can be sufficiently limited through heat exchange between the tank 10 and external air. The controller 50 closes the tank temperature control passage by setting the open degree of the electromagnetic valve 23 to 0% when the amount of fuel injected by the fuel injection valve 13 is less than or equal to a specified injection amount. The specified injection amount has been set in advance. In the case of FIG. 3, the specified injection amount is a.

The pressure of the hydrogen gas in the tank 10 is reduced as the amount of injection performed by the fuel injection valve 13 increases. Thus, the temperature of the hydrogen gas in the tank 10 decreases as the amount of injection performed by the fuel injection valve 13 increases. To properly heat the hydrogen gas within the tank 10, it is necessary to increase the amount of coolant used for heat exchange with the tank 10 as the temperature of the hydrogen gas decreases. As shown in FIG. 3, when the injection amount is greater than a, the controller 50 increases the open degree of the electromagnetic valve 23 as the amount of fuel injected by the fuel injection valve 13 increases. In this manner, the controller 50 controls the electromagnetic valve 23 such that the greater the amount of fuel injected by the fuel injection valve 13, the greater the amount of coolant that flows through the tank temperature control passage.

In FIG. 3, the open degree of the electromagnetic valve 23 reaches 100% when the amount of injection performed by the fuel injection valve 13 is b. The open degree of the electromagnetic valve 23 does not exceed 100%. Thus, when the amount of injection performed by the fuel injection valve 13 exceeds b, the open degree of the electromagnetic valve 23 is maintained at 100%. In other words, the open degree of the electromagnetic valve 23 increases within the range from 0% to 100% depending on the amount of injection performed by the fuel injection valve 13. The open degree of the electromagnetic valve 23 does not exceed the upper limit of 100%, even if the amount of injection performed by the fuel injection valve 13 becomes greater than or equal to the specified injection amount.

After the controller 50 determines the open degree of the electromagnetic valve 23 based on the injection amount as shown in the graph in FIG. 3 in the open degree determination process, it proceeds to the next step S13. In the process of step S13, the controller 50 controls the electromagnetic valve 23 such it achieves the open degree determined in the open degree determination process of step S12. The controller 50 subsequently terminates this series of processes.

In the process of step S10, when the controller 50 determines that the shut-off valve 11 is not open (step S10: NO), the process proceeds to step S14. Additionally, in the process of step S11, when the controller 50 determines that the temperature of the coolant is not higher than the temperature in the tank 10 (step S11: NO), the process also advances to step S14. In other words, the controller 50, during the process of step S11, will advance the process to step S14 even if it determines that the temperature of the coolant is lower than the temperature in the tank 10.

In the process of step S14, the controller 50 closes the electromagnetic valve 23. That is, the controller 50 sets the open degree of the electromagnetic valve 23 to 0%. Subsequently, the controller 50 concludes this series of processes.

### Operation of Present Embodiment

The thermal management system 100 limits temperature changes in the hydrogen gas in the tank 10 by exchanging heat between the coolant that has flowed through engine 14 and the tank 10.

### Advantages of Present Embodiment

(1) The thermal management system 100 limits changes in the density of hydrogen gas in the tank 10 due to its temperature variations. In other words, the thermal management system 100 limits a decrease in the fuel injection control accuracy by mitigating temperature variations in the hydrogen gas.

(2) The controller 50 is configured to control, when controlling the electromagnetic valve 23 such that coolant flows through the tank temperature control passage, the electromagnetic valve 23 such that the amount of the coolant flowing through the tank temperature control passage increases as the amount of hydrogen gas injected by the fuel injection valve 13 increases. The temperature of the hydrogen gas in the tank decreases as the amount of the hydrogen gas injected by the fuel injection valve 13 increases. When the amount of the hydrogen gas injected by the fuel injection valve 13 is relatively small, the thermal management system 100 reduces the amount of the coolant flowing through the tank temperature control passage. When the amount of the hydrogen gas injected by the fuel injection valve 13 is relatively large, the thermal management system 100 increases the amount of the coolant flowing through the tank temperature control passage. This allows the thermal management system 100 to control the amount of the coolant flowing through the tank temperature control passage according to the temperature variation tendency of the hydrogen gas in the tank 10. This allows the tank 10 to be heated properly.

(3) The controller 50 is configured to control the electromagnetic valve 23 such that coolant does not flow through the tank temperature control passage when the amount of hydrogen gas injected by the fuel injection valve 13 is less than or equal to the specified injection amount. When the hydrogen gas is injected from the fuel injection valve 13, the pressure of the hydrogen gas in the tank 10 is reduced. As the pressure of the hydrogen gas in the tank 10 decreases, its temperature decreases. Thus, it is desirable for the decrease in the temperature of the hydrogen gas to be limited by heating the tank 10 during the operation of the engine 14, into which the hydrogen gas is injected from the fuel injection valve 13. However, when the amount of the hydrogen gas injected by the fuel injection valve 13 is relatively small, the decrease in the temperature of the hydrogen gas in the tank 10 can be sufficiently limited through heat exchange between the tank 10 and external air. Thus, when the amount of the hydrogen gas injected by the fuel injection valve 13 is relatively small, the thermal management system 100 closes the tank temperature control passage to limit heat exchange between the tank 10 and the coolant. This allows the thermal management system 100 to prevent unnecessary heating of the tank 10.

(4) The controller 50 is configured to control the electromagnetic valve 23 such that coolant does not flow through the tank temperature control passage when the temperature of the coolant that has flowed from the engine 14 and has not yet reached the heat exchanger 24 is less than the temperature in the tank 10. Further, the controller 50 is configured to control the electromagnetic valve 23 such that coolant flows through the tank temperature control passage when the temperature of the coolant that has flowed from the engine 14 and has not yet reached the heat exchanger 24 is greater than or equal to the temperature in the tank 10. When the temperature of the coolant is lower than the temperature in the tank 10, the coolant cools the tank 10. When the temperature of the coolant is lower than the temperature in the tank 10, the thermal management system 100 closes the tank temperature control passage to prevent heat exchange between the coolant and the tank 10. Only when the temperature of the coolant is greater than or equal to the temperature in the tank 10, the thermal management system 100 opens the tank temperature control passage to promote the heat exchange between the coolant and the tank 10. This allows the thermal management system 100 to efficiently heat the tank 10 using coolant.

(5) The thermal management system 100 further includes the radiator passage, which is arranged to cause the coolant that has flowed from the engine 14 to return to the engine 14 sequentially through the radiator 22, the thermostat valve 21, and the water pump 20. The radiator passage includes the first connection point 36, which is located at the portion through which the coolant that has flowed from the engine 14 and has not yet reached the radiator 22 flows. The radiator passage includes the second connection point 37, which is located at the portion through which the coolant that has flowed through the radiator 22 and has not yet reached the thermostat valve 21 flows. The tank temperature control passage is connected to the radiator passage at the first connection point 36 and the second connection point 37 such that the coolant that has flowed from the engine 14 flows sequentially through the first connection point 36, the heat exchanger 24, the second connection point 37, the thermostat valve 21, and the water pump 20 and returns to the engine 14. The thermostat valve 21 is configured to open the radiator passage and the tank temperature control passage when the warm-up of the engine 14 is completed. The thermostat valve 21 is configured to close the radiator passage and the tank temperature control passage when the warm-up of the engine 14 is not completed.

When the warm-up of the engine 14 is not completed, the temperature of the coolant is relatively low. Thus, even if the coolant flows through the heat exchanger 24 when the warm-up of the engine 14 is not completed, the coolant cannot heat the tank 10. When the warm-up of the engine 14 is completed, the coolant has been heated. Thus, the coolant that has flowed through the engine 14 can heat the tank 10. When the warm-up of the engine 14 is not completed, the thermal management system 100 closes the radiator passage and the tank temperature control passage to prevent heat exchange between the coolant and the tank 10. When the warm-up of the engine 14 is completed, the thermal management system 100 opens the radiator passage and the tank temperature control passage to promote heat exchange between the coolant and the tank 10. This allows the thermal management system 100 to heat the tank 10 by using the heat of the coolant after warm-up is completed.

### Modifications

The present embodiment may be modified as follows. the present embodiment and the following modifications can be combined as long as the combined modifications remain technically consistent with each other.

In the controller 50 of the present embodiment, during the open degree determination process in step S12 in FIG. 2, the open degree of the electromagnetic valve 23 is set to 0% when the amount of injection performed by the fuel injection valve 13 is less than or equal to the specified injection amount. In contrast, as shown in FIG. 4, the controller 50 may increase the open degree of the electromagnetic valve 23 depending on the increase in the injection amount from zero, without setting the specified injection amount during the open degree determination process.

In the present embodiment, the electromagnetic valve 23 is installed in the fourth coolant pipe 34. The electromagnetic valve 23 may be installed at the first connection point 36.

In the present embodiment, the coolant temperature sensor 41 is installed in the section of the first coolant pipeline 31 between the engine 14 and the first connection point 36. The coolant temperature sensor 41 may be installed at any location if it can measure the temperature of the coolant that has flowed from the engine 14 and has not yet reached the heat exchanger 24. The coolant temperature sensor 41 may be installed, for example, in the fourth coolant pipe 34. A coolant temperature sensor 41 may be installed, for example, at the first connection point 36 in the first coolant pipe 31. The coolant temperature sensor 41 may be installed, for example, in the section of the first coolant pipe 31 between the first connection point 36 and the radiator 22.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A thermal management system employed in a vehicle including a fuel supply system configured to supply hydrogen gas as fuel to an engine, the fuel supply system including a tank configured to store the hydrogen gas, a fuel injection valve configured to inject the hydrogen gas, and a regulator configured to control a pressure of the hydrogen gas supplied from the tank to the fuel injection valve, the thermal management system comprising:
a heat exchanger configured to exchange heat between coolant for the engine and the tank;
a tank temperature control passage configured to cause the coolant that has flowed from the engine to return to the engine through the heat exchanger;
an electromagnetic valve configured to regulate an amount of the coolant flowing through the tank temperature control passage; and
processing circuitry configured to control the electromagnetic valve, wherein
the processing circuitry is configured to adjust the amount of coolant flowing through the tank temperature control passage by controlling the electromagnetic valve.

2. The thermal management system according to claim 1, wherein
the processing circuitry is configured to control the electromagnetic valve such that the amount of the coolant flowing through the tank temperature control passage increases as an amount of the hydrogen gas injected by the fuel injection valve increases.

3. The thermal management system according to claim 1, wherein
the processing circuitry is configured to control the electromagnetic valve such that the coolant does not flow through the tank temperature control passage when an amount of the hydrogen gas injected by the fuel injection valve is less than or equal to a specified injection amount.

4. The thermal management system according to claim 1, wherein
the processing circuitry is configured to:
control the electromagnetic valve such that the coolant does not flow through the tank temperature control passage when a temperature of the coolant that has flowed from the engine and has not yet reached the heat exchanger is less than a temperature in the tank; and
control the electromagnetic valve such that the coolant flows through the tank temperature control passage when the temperature of the coolant that has flowed from the engine and has not yet reached the heat exchanger is greater than or equal to the temperature in the tank.

5. The thermal management system according to claim 1, further comprising a radiator passage arranged to cause the coolant that has flowed from the engine to return to the engine sequentially through a radiator, a thermostat valve, and a water pump, wherein
the radiator passage includes:
a first connection point located at a portion through which the coolant that has flowed from the engine and has not yet reached the radiator flows; and
a second connection point located at a portion through which the coolant that has flowed through the radiator and has not yet reached the thermostat flows,
the tank temperature control passage is connected to the radiator passage at the first connection point and the second connection point such that the coolant that has flowed from the engine flows sequentially through the first connection point, the heat exchanger, the second connection point, the thermostat valve, and the water pump and returns to the engine, and
the thermostat valve is configured to:
open the radiator passage and the tank temperature control passage when warm-up of the engine is completed; and
close the radiator passage and the tank temperature control passage when warm-up of the engine is not completed.
